(19) United States
(12) Patent Application Publication
(10) Pub. No.: US 2002/0073020 A1
(43) Pub. Date: Jun. 13, 2002

(54) Method of purchasing a loan for resale to a buyer

(76) Inventors: Stuart McFarland, Washington, DC (US); Martin Heck, Reston, VA (US)

Correspondence Address: Edward A. Pennington, SWIDLER BERLIN SHEREFF FRIEDMAN, LLP, Suite 300, 3000 K Street, N.W., Washington, DC, 20007-5166, US

(21) Appl. No.: 09/733,032

(22) Filed: Dec. 11, 2000

(51) Int. Cl. G06F 17/60

(52) U.S. Cl. 705/38

(57) ABSTRACT

A method of facilitating mortgage loan resale is disclosed. The method includes purchasing an interest in a loan from a loan originator, creating specialized loan information, providing the specialized information to a predetermined buyer, and selling the interest to the predetermined buyer. The method also discloses a risk allocation scheme whereby loan risk is allocated among the loan originator and the predetermined buyer.

### BACKGROUND OF THE INVENTION

The present invention relates to a method of purchasing of loans, and more particularly to a method of purchasing loans for resale to designated buyers. Commonly a loan origination institution, or correspondent lender, that offers and makes a loan, such as a mortgage loan, does not maintain the loan in its portfolio. Instead, it may decide to sell the beneficial rights and/or the servicing rights to the loan in the secondary mortgage market.

However, the various secondary market loan buyers have differing requirements for purchasing loans. The requirements are as varied as the buyers in the secondary market are. Common requirements include a minimum portfolio amount, restricted property types, limits on the loan amounts within a portfolio, and certain loan documentation particularities. The documentation evidences loan information. The documentation can evidence, for example, loan origination or current loan status and/or beneficial ownership of a loan. As an example, loan information can include one or more of borrower information, property information and/or term and condition information. The borrower information can include, but is not limited to, information that identifies a borrower and the borrower's eligibility for a loan. The property information can include, but is not limited to, information that describes the property that is the subject of the loan. Lastly, terms and condition information can include, as the name implies, terms and conditions of the loan. Information can also include the documentation, either in physical or electronic form that evidences the information being conveyed.

Because of the various requirements, many correspondent lenders do not have full access to all buyers in the secondary mortgage market. The diversity and burdens of such requirements inhibit many loan originators from fully participating in the secondary mortgage marketplace. For example, some loan originators may not be in a position to meet the minimum portfolio amount or the risk factors that a buyer may demand. In addition, it is expensive for loan originators to track the various documentation required by specific buyers, and to convert their loan documentation into a form required by the various buyers in the secondary market.

A need therefore exists to alleviate the burdens on loan originators and thus reduce the barriers that loan originators face in attempting to market their loan portfolio. As an example the Federal Home Loan Bank requires that the loan originator first get a Master Commitment detailing the maximum credit risk exposure that the loans that they sell to them can have, with MPF Link they do not have such a requirement.

One of the largest supplier of home mortgage credit in the United States is the Federal Home Loan Bank System (FHLBanks) and with their 6,500 members. FHLBanks are privately capitalized, cooperative government-sponsored enterprises. There are twelve regional FHLBanks; a fiscal agent, an Office of Finance; and a regulator, the Federal Housing Finance Board (FHFB). The mission of the FHLBanks is to support residential mortgage lending by their member-stockholders. Eligible members include commercial banks, savings institutions, credit unions, and insurance companies. The FHLBanks provide members with access to economical wholesale credit products.

Each FHLBank is a separate corporate entity with its own board of directors, management team and members. The FHLBanks are self-supporting, profit-making organizations which do not receive any taxpayer assistance. The FHLBanks raise funds by issuing debt instruments (bonds and notes) in the capital markets. Because of the high rating of their consolidated debt, they can raise funds at a rate only slightly higher than that paid by the U.S. Treasury. The FHLBanks are then able to provide loans, called advances, to members at costs that are generally lower than other wholesale funding sources. This makes the FHLBanks a desirable source of credit.

The Federal Housing Finance Board authorized the Federal Home Loan Bank of Chicago (FHLBC) to originate and hold residential mortgages under a Mortgage Partnership Finance (MPF) program. In this program, FHLBC members receive fees for originating mortgages, assume credit losses for the FHLBC, and service the mortgages. The program's loan limit is the same as the FNMA/FHLMC limit. Members share credit risk through a fund comprising a portion of the mortgage interest payments.

Unlike traditional secondary market programs, FHLBC does not charge a guarantee fee. Rather, the member receives a fee from the FHLBC for providing second-loss credit enhancement. The goal of the program is to lower the current cost to regulated portfolio lenders of originating and holding mortgages versus originating and selling mortgages to Fannie Mae or Freddie Mac. The savings come in the form of lower risk-based and leverage capital requirements and alignment of the cost of credit enhancement with actual credit losses.

### SUMMARY OF THE INVENTION

It is an object of the present invention to provide a method of purchasing a loan for sale to a buyer that overcomes many of the burdens that currently face correspondent lenders in selling loans into the MPF program.

It is a further object of the present invention to provide a method of purchasing a loan for sale to a buyer that allows the buyer to simply and inexpensively offer loan portfolios to secondary mortgage market buyers.

It is another object of the present invention to provide a method of purchasing a loan for sale to a buyer that minimizes the tasks a seller must perform in order to prepare a loan for the secondary market.

It is still a further object of the present invention to provide a method of purchasing a loan for sale to the Federal Home Loan Bank.

### BRIEF DESCRIPTION OF THE DRAWINGS

FIG. 1 shows a preferred embodiment of the process of the present invention.

### DESCRIPTION OF THE PREFERRED EMBODIMENTS

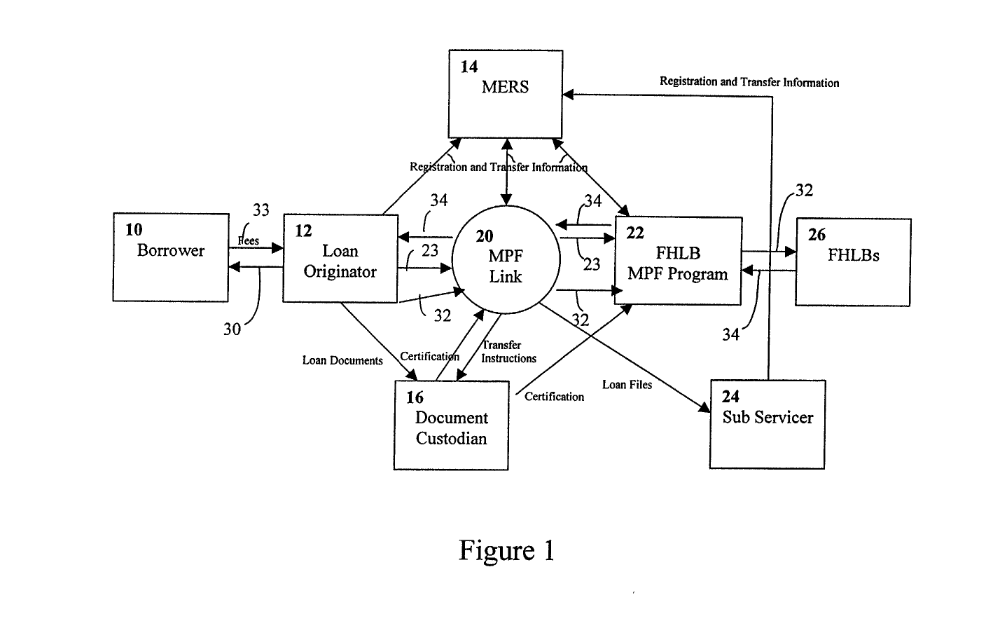

Referring to FIG. 1, a borrower 10 obtains a mortgage loan for funds 30 from a loan originator, or correspondent lender, 12 in known fashion. The loan originator 12 can register mortgages with the Mortgage Electronic Registration System (MERS) 14, which is an industry standard electronic system for registering and tracking mortgage rights through a central loan data registry.

Should loan originator 12 wish to sell either the beneficial rights 32 or the servicing right for the loan 30 to a secondary loan buyer (FHLB MFP Program) 22, it is necessary for loan originator 12 to produce loan information 23 in a specific form required by the specific secondary loan buyer 22. Freddie Mac and Fannie Mae each have their own file formats and systems to transmit loan data in order to purchase loans. Secondary buyers 22 typically use loan information 23 to determine whether to purchase the beneficial rights 32 in loan 30. Typically, each secondary buyer 22 requires differing forms of loan information 23. Thus, as noted above, it is necessary for loan originator 12 to invest time and effort into researching and producing each form of loan information 23 required by the various secondary buyers 22.

The present invention, however, alleviates this problem by allowing loan originator 12 to reach numerous secondary loan buyers 22 via a single transaction with MPF Link 20. Referring to FIG. 1, MPF Link 20 purchases, as an agent for the purchaser, beneficial rights 32 from loan originator 12. MPF Link 20 then establishes communication with MERS 14 to register the loan 30, if not already registered, to indicate the change in ownership of the beneficial rights 32 and servicing rights if applicable. Based upon the characteristics of the particular loan 30 in question, MPF Link 20 sells the loan 30 to the appropriate secondary loan buyers 22. MPF Link 20 then initiates preparation of the loan information 23 required by the selected secondary buyer 22. The loan information 23 can be prepared by MPF Link 20 or by a document custodian 16. 17. MPF Link 20 then initiates transfer of the appropriate form of loan information 23 to the respective secondary buyers 22. This transfer can be done by MPF Link 20 or by the document custodian 16 at the direction of MPF Link 20. If appropriate, MERS 14 is updated, and funds 34 are transferred to MPF Link 20 or the purchaser/seller for whom MPF Link 20 performs there processes.

In addition to providing loan information 23 in the appropriate form to secondary buyer 22, MPF Link 20 also develops a risk allocation arrangement with another entity. Identifying and obtaining the risk allocation arrangement allows MPF Link 20 to offer a loan to a secondary buyer 22 that would otherwise be unacceptable to the secondary buyer 22. MPF Link 20 provides access to multiple PFIs who have contracted with MPF Link to provide outsourced services for purchasing loans for subsequent sale into the MPF program, to loan originators 12 who wish to sell loans into the MPF program but do not wish to retain credit risk on those loans. The PFI's assume the credit risk with the MPF program in return for credit enhancement fees provided by the FHLBanks 26.

Referring to FIG. 1, MPF Link 20 also allows for the purchase of the servicing right from the loan originator 12. These rights can be held by MPF Link 20, as agent for the purchaser, until transferred to a sub servicer 24 as shown in FIG. 1.

While the preferred embodiments of the present invention have been described above, it should be understood that they have been presented by way of example only, and not of limitation. It will be apparent to persons skilled in the relevant art that various changes in form and detail can be made therein without departing from the spirit and scope of the invention. Thus the present invention should not be limited by the above-described exemplary embodiments, but should be defined only in accordance with the following claims and their equivalents.

What is claimed is:

1. A method of purchasing a loan for sale to a predetermined buyer, comprising:
a) receiving loan information;
b) purchasing a beneficial rights to the loan;
c) providing processed loan information required by the predetermined buyer;
d) developing a risk arrangement for the loan;
e) providing the processed loan information and risk arrangement to the predetermined buyer;
f) receiving loan funds for the loan from the predetermined buyer; and
g) providing the loan funds.

2. A method of purchasing a loan according to claim 1, wherein the providing processed loan information includes causing a third organization to create the processed loan information.

3. A method of purchasing a loan according to claim 1, wherein step e) includes providing the processed loan information and risk arrangement to a Federal Home Loan Bank.

4. A method of purchasing a loan according to claim 3, wherein step b) further comprises purchasing a servicing right to the loan.

5. A method of purchasing a loan according to claim 1, wherein step b) further comprises purchasing a servicing right to the loan.

6. A method of selling a loan to a predetermined buyer, comprising:
a) receiving loan information from a first organization;
b) purchasing a beneficial rights to the loan from the first organization;
c) providing processed loan information required by the predetermined buyer;
d) developing a risk arrangement for the loan with a second organization;
e) providing the processed loan information and risk arrangement to the predetermined buyer;
f) receiving loan funds; and
g) providing the loan funds.

7. A method of selling a loan according to claim 6, wherein the providing processed loan information includes causing a third organization to create the processed loan information.

8. A method of selling a loan according to claim 6, wherein step e) includes providing the processed loan information and risk arrangement to a Federal Home Loan Bank.

9. A method of selling a loan according to claim 8, wherein step b) further comprises purchasing a servicing right to the loan.

10. A method of selling a loan according to claim 6, wherein step b) further comprises purchasing a servicing right to the loan.
